(19) United States
(12) Patent Application Publication
(10) Pub. No.: US 2025/0007789 A1
(43) Pub. Date: Jan. 2, 2025

(54) CONFIGURING A USER EQUIPMENT WITH MACHINE LEARNING MODELS BASED ON COMPUTE RESOURCE LIMITS

(71) Applicant: QUALCOMM Incorporated, San Diego, CA (US)

(72) Inventors: Yuwei REN, Beijing (CN); June NAMGOONG, San Diego, CA (US); Huilin XU, Temecula, CA (US)

(21) Appl. No.: 18/294,959

(22) PCT Filed: Oct. 27, 2021
(86) PCT No.: PCT/CN2021/126567

§ 371 Date: Feb. 2, 2024

(51) Int. Cl. H04L 41/16; H04L 41/14

(52) U.S. Cl. CPC H04L 41/16; H04L 41/145

(57) ABSTRACT

Certain aspects of the present disclosure provide techniques for configuring a user equipment (UE) with machine learning models based on compute resource limits for the UE. An example method generally includes generating a set of machine learning models for use in a wireless communications device based on one or more compute resource limits associated with a type of the wireless communications device; and deploying the generated set of machine learning models.

### INTRODUCTION

Aspects of the present disclosure relate to wireless communications, and more particularly, to techniques for configuring user equipments (UEs) with machine learning models based on compute resource limits for these UEs.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a wireless communication device. An example method generally includes generating a set of machine learning models for use in a wireless communications device based on one or more compute resource limits associated with a type of the wireless communications device; and deploying the generated set of machine learning models.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 illustrates example operations for wireless communication by a wireless communication device to configure a user equipment (UE) with one or more machine learning models based on compute resource limits for the UE, in accordance with certain aspects of the present disclosure.

FIG. 5 illustrates example memory usage of a multi-layer machine learning model which a UE may be configured to use based on compute resource limits for the UE, in accordance with certain aspects of the present disclosure.

FIG. 6 depicts aspects of an example communications device.

### DETAILED DESCRIPTION

Aspects of the present disclosure provide apparatuses, methods, processing systems, and computer-readable mediums for configuring a user equipment (UE) with a set of machine learning models that the UE can use based on compute resource limits associated with the UE.

In wireless communications systems, machine learning models can be used for various predictive purposes. For example, machine learning models can be used to predict channel state information (CSI) measurements for use in reporting CSI to a network entity (e.g., a base station, such as a gNodeB or eNodeB) at a future point in time. In another example, machine learning models can be used to identify sounding and precoding matrices for an uplink transmission from the UE to a network entity for use in beamforming transmissions to maximize a received signal strength of the transmission.

Performing inferences using machine learning models generally imposes a computational overhead on a device on which these machine learning models are deployed. Different types of UEs, however, may have different computational capabilities, and thus, may not be able to perform inferences using the same machine learning models. For example, a high-cost UE with powerful processors (e.g., central processing units (CPUs), graphics processing units (GPUs), neural processing units (NPUs), etc.) may be able to perform inferences using complex machine learning models, but other UEs may have less powerful processors (e.g., due to cost or power usage concerns) or other limitations that may prevent these UEs from performing inferences using the complex machine learning models that can be executed using high-cost UEs.

In some cases, to configure a wide variety of UEs to perform inferences using a set of machine learning models, the set of machine learning models may be defined with respect to a baseline UE with a defined baseline set of compute resources or computing capabilities (e g., processing power, in terms of instructions or operations executed over a period of time; memory; number of parallel operations supported, etc.). By defining a set of machine learning models with respect to this baseline UE, a wide variety of UEs, including UEs with more available compute resources than this baseline UE, can perform inferences using models in this defined set of machine learning models. However, because the set of machine learning models may be defined with respect to a baseline UE, performing inferences using this set of machine learning models on UEs with more compute resources than the baseline UE may leave some resources unused and may result in lower inference performance than would be experienced if more complex models were executed on these UEs with more compute resources than the baseline UE.

Aspects of the present disclosure provide techniques for configuring UEs with sets of machine learning models based on compute resource limits associated with a UE and computational complexity of machine learning models in an overall set of machine learning models from which the UE can be configured. Generally, the set of models with which the UE is configured may be tailored to the compute resources available at that UE (or class of UEs). Thus, different UEs may be configured with different sets of machine learning models. By configuring a UE with machine learning models based on the compute resource limits associated with the UE and compute resource utilization associated with each of a plurality of UEs, a UE may be configured with a set of machine learning models that are suitable for use by that UE and do not exceed the computational capabilities of the UE. Further, the set of machine learning models may include models of varying complexity, which may allow for inferences to be performed using a variety of machine learning models with varying levels of accuracy, based on an amount of accuracy needed for a given task.

### Introduction to Wireless Communication Networks

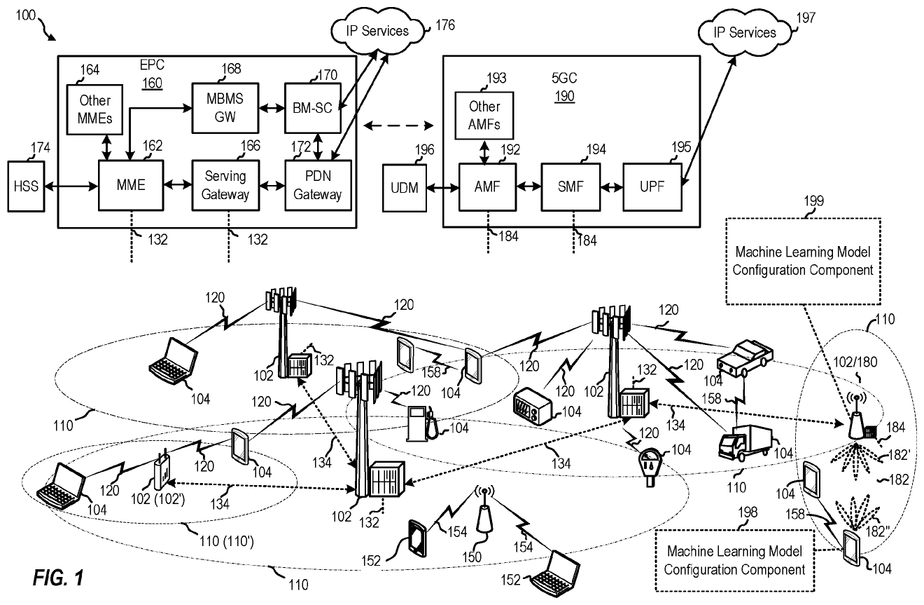

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Wireless communication network 100 includes machine learning model configuration component 199, which may be configured to configure machine learning models for the UE to use in performing inferences at the UE. Wireless network 100 further includes machine learning model configuration component 198, which may be configured to configure a UE with machine learning models to use in performing inferences at the UE.

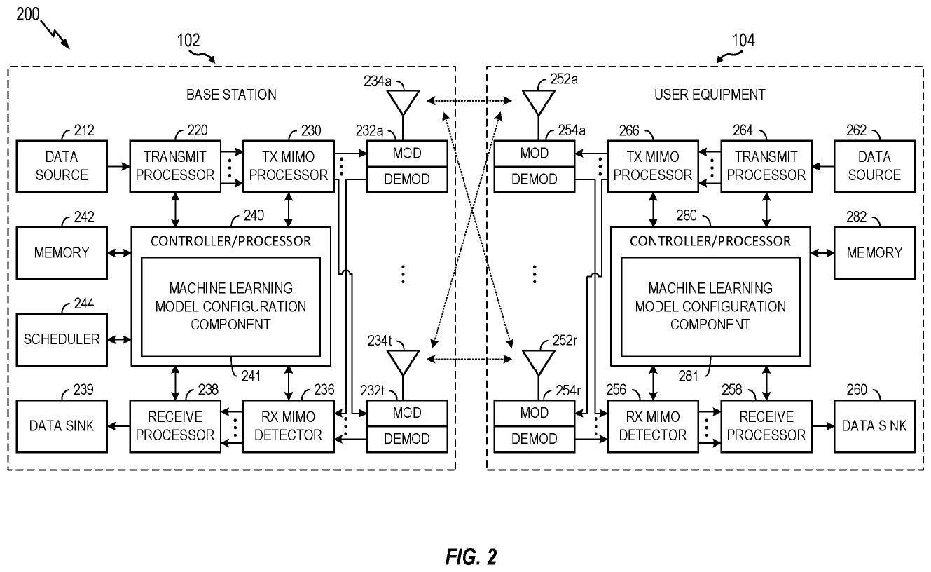

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., source data 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes machine learning model configuration component 241, which may be representative of machine learning model configuration component 199 of FIG. 1. Notably, while depicted as an aspect of controller/processor 240, machine learning model configuration component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., source data 262) and wireless reception of data (e.g., data sink 260).

User equipment 102 includes controller/processor 280, which may be configured to implement various functions related to wireless communications. In the depicted example, controller/processor 280 includes machine learning model configuration component 281, which may be representative of machine learning model configuration component 198 of FIG. 1. Notably, while depicted as an aspect of controller/processor 280, machine learning model configuration component 281 may be implemented additionally or alternatively in various other aspects of user equipment 104 in other implementations.

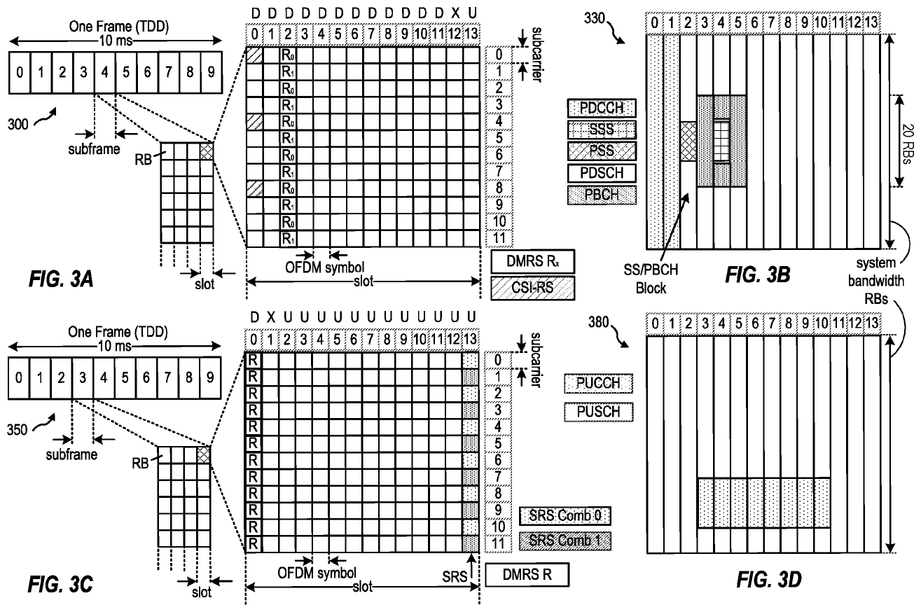

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Configuring a User Equipment (UE) With Machine Learning Models Based on Compute Resource Limits for the UE

Machine learning models may be defined in terms of computational complexity and memory needed to perform inferences using these machine learning models. Computational complexity may be represented by a number of mathematical operations performed in order to perform an inference and may account for the different levels of complexity for different types of mathematical operations. For example, multiplications may be more complex than additions within a circuit. In another example, complexity may be influenced by the type of data used within a machine learning models. Small integers may be the least computationally expensive to process, while processing large floating point numbers (e.g., double precision floating point numbers) may be significantly more computationally expensive. Further, machine learning models may use varying amounts of system memory. A machine learning model may include multiple layers, and different layers may correspond to different memory expenditure. This memory expenditure may be influenced, for example, by the size of a layer in the machine learning model (e.g., how data is compressed or expanded relative to a previous layer in the machine learning model) and the type of data used in the machine learning model (e.g., where data represented using larger bit sizes correspond to a larger memory footprint for the machine learning model than data represented using smaller bit sizes).

As discussed, different UEs may have different compute capabilities, which may correspond to the computing resources (e.g., processing power, parallel processing capabilities provided by a number of logical and/or physical cores in a processor, the amount of installed memory, etc.) available on these UEs. Because different UEs may have different compute capabilities, a predefined set of machine learning models may not be appropriate for the UE. For example, a set of low-complexity machine learning models may be appropriate for low-cost UEs or low-complexity UEs operating with limited computing resources (e.g., due to power usage requirements, size, etc.), but may not be appropriate for UEs with more extensive compute capabilities. This may be the case because UEs with more extensive compute capabilities may be capable of performing inferences with higher accuracy (e.g., using higher precision floating point number-based models instead of lower precision floating point number-based models or integer-based models) than the accuracy supported by the models in the set of low-complexity machine learning models. Similarly, a set of high-complexity machine learning models (e.g., double precision floating point number-based models, single precision floating point number-based models, etc.) may be appropriate UEs with extensive compute capabilities, but may be inappropriate for low-cost UEs and/or low-complexity UEs, as low-cost UEs and/or low-complexity UEs may not have sufficient compute resources needed to perform inferences using these machine learning models.

To account for the different compute capabilities of different UEs, aspects of the present disclosure provide techniques for configuring UEs with a set of machine learning models based on compute resource limits for the UE. By configuring UEs with different sets of machine learning models based on the compute resource limits for the UE, UEs can be configured with sets of machine learning models that are appropriate for the amount of compute resources available at the UE while balancing other factors, such as the accuracy of inferences performed by the UE, the number of models that can be executed concurrently, the number of models the UE can select to perform inferences, and the like.

In some aspects, compute resource limits may be defined for a set of machine learning models with which the UE is to be configured. The compute resource limits may be a single limit or may be a set of limits. Where the compute resource limit is defined as a single limit, the set of machine learning models may satisfy the single limit. That is, the total compute resources used by the set of machine learning models may not exceed this single compute resource limit. Where the compute resource limit is defined as multiple limits, the set of machine learning models may satisfy the multiple limits in total. That is, the total compute resources used by the set of machine learning models may not exceed any compute resource limit of the multiple compute resource limits.

Compute resource limits may be defined for a plurality of metrics. For example, a compute resource limit may be defined for model computational complexity. Model computational complexity may be defined, for example, in terms of a number of instructions performed over a given time period (e.g., in terms of millions of operations per second, or MIPS) or a number of specific types of instructions performed over the given time period (e.g., in terms of floating point operations per second, or FLOPS). To determine the number of operations performed during execution of a machine learning model, a device configuring the UE with the set of machine learning models can examine each machine learning model to determine the number of instructions executed in order to generate an inference. This determined number of operations performed during execution of the machine learning model can be used to reach the instructions performed over a time period compute resource limit.

In another example, a compute resource limit may be defined in terms of a total amount of memory that can be used by one or more machine learning models executing on a UE. To ensure that the machine learning models included in the set of machine learning models can execute in parallel, each machine learning model can be examined for a maximum memory utilization for the machine learning model. The maximum memory utilization for the machine learning model may correspond, for example, to a memory utilization at the largest layer of the machine learning model, and the total memory utilization of the machine learning models in the set may assume concurrent execution of the largest layer of each machine learning model so that in an extreme scenario, the UE has a sufficient amount of memory allocated to the machine learning models to execute these machine learning models simultaneously or substantially simultaneously. In some aspects, overall memory usage may allow for memory usage to be considered for each of a plurality of configured machine learning models while disregarding, or at least minimizing consideration of, which layer(s) in memory (e.g., different layers of processor cache, system random access memory, etc.) are used during execution of a machine learning model, as the location of data in memory may be different at different execution times or on different devices.

In still another example, a compute resource limit may be defined in terms of a number of models that can execute simultaneously or substantially simultaneously. The number of models that can execute simultaneously or substantially simultaneously may be based, for example, on a number of logical or physical cores present in a processor on the UE. In some aspects, some cores may be excluded from use in performing inferences using models in the set of machine learning models, which may influence the number of models that can execute simultaneously or substantially simultaneously. For example, in a heterogeneous processing architecture including “big” cores and “little” cores, the “little” cores may be disregarded in the determination of the number of models that can execute simultaneously or substantially simultaneously.

It should be understood that the computational complexity, memory, and number of models compute resource limits discussed above are only examples of compute resource limits that may be established and used to identify machine learning models that can be deployed on a UE (or a type of UE). Other compute resource limits, associated with other types of resources, performance metrics, or the like may also or alternatively be used in identifying machine learning models that can be deployed on a UE (or a type of UE).

The compute resource limits discussed herein may generally be established for different types, or classes, of UEs. For example, low complexity UEs, such as Machine Type Communication (MTC) UEs, bandwidth reduced low complexity/coverage enhancement (BL/CE) UEs, or the like, may be associated with a first set of compute resource limits. Other UEs, such as smartphones, tablets, or other devices which may be expected to have greater computational resources than low complexity UEs, may be associated with a second set of compute resource limits different from the first set of compute resource limits. It should be noted that the compute resource limits established for each type (or class) of UE may be established based on the computational capabilities that any UE in the type (or class) of UEs may be expected to have, which may simplify the configuration of machine learning models for a UE relative to using the measured performance of any specific UE. For example, a given type of UE may be expected to be able to execute a set number of operations over a given amount of time, may be expected to have at least a minimum amount of memory that can be reserved for loading one or more machine learning models in memory, and may be expected to support a minimum amount of parallel processing, and compute limits may be established for the type of UE based on these expected computational capabilities.

In some aspects, as discussed, the compute resource limits may include one or more of limits, including the compute resource limits discussed above and other compute resource limits that may be used to control the machine learning models with which a UE is configured. For example, assume that a UE is configured with the set of limits L_{T}={L_{T, 1}, L_{T, 2}, L_{T, 3}}. L_{T, 1} may correspond to a computational complexity limit, L_{T, 2} may correspond to a model memory limit, and L_{T, 3} may correspond to a number of models limit, as discussed above. When a UE is being configured with the set of machine learning models, the machine learning models may collectively satisfy each of these limits L_{T, 1}, L_{T, 2}, and L_{T, 3}, and may not exceed any one of these limits.

For example, suppose that L_{T, 1=2} million MIPS, L_{T, 2=50} megabytes, and L_{T, 3=20} models. When identifying the models with which the UE is to be configured, these limits may be decremented until each of these limits approaches 0. Suppose that a set of machine learning models has a compute complexity of 1 million MIPS, memory of 30 megabytes, and a total number of 50 models. While this set of models satisfies L_{T, 1} and L_{T, 2} (e.g., the compute complexity and memory utilization limits), this set of models includes a number of models in excess of the maximum number of models supported by the UE. Thus, this set of machine learning models may be invalid for the UE and may need to be reduced in order to satisfy the compute resource limits for the UE.

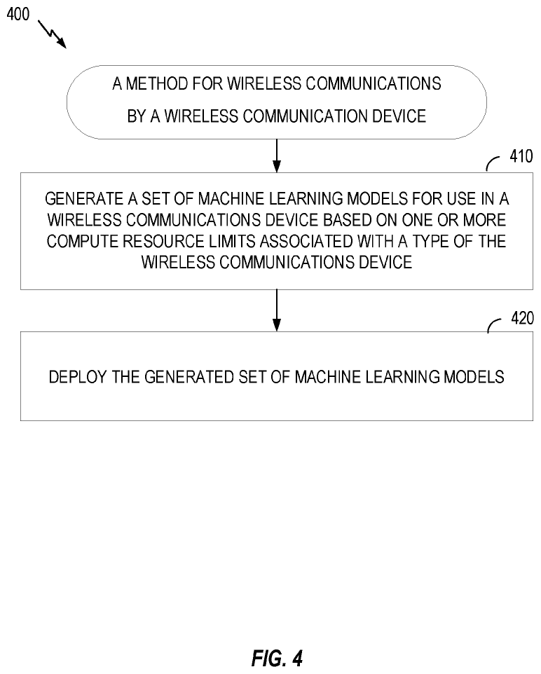

FIG. 4 illustrates example operations 400 that may be performed to configure a UE with a set of machine learning models based on compute resource limits associated with the UE. Operations 400 may be performed, for example, by machine learning model configuration component 198 of FIG. 1 (e.g., where a UE configures itself with the set of machine learning models) or machine learning model configuration component 199 of FIG. 1 (e.g., where a UE is being configured with the set of machine learning models by a network entity such as a gNodeB or other base station).

As illustrated, operations 400 may begin at block 410, where a set of machine learning models is generated for use in a wireless communications device. The set of machine learning models may be generated based on one or more compute resource limits associated with a type of the wireless communications device. For example, the set of machine learning models may be generated based on one or more of a global set of compute resource limits including a computational complexity limit over the set of models, a memory limit over the set of models, and a total number of configured models limit, as discussed above. In some aspects, as discussed in further detail below, the set of machine learning models may be further generated on one or more per-model limits. The set of machine learning models may include one or more machine learning models from a global set of machine learning models with which a wireless communications device can be configured.

At block 420, the generated set of machine learning models is deployed. Deploying the generated set of machine learning models may include transmitting, to the UE being configured, identifiers associated with models in the generated set of models. In this case, information defining each model in a global set of models may be stored at the UE, and each model may be associated with an identifier. The transmitted identifiers may identify the models in the global set of models that the UE can use to perform inferences. The UE can designate these models as available for use, and can designate models other than the models in the generated set of machine learning models as blocked from use. The designations of models as available for use and blocked from use may be valid until a new set of identifiers is received. The global set of models may include, for example, a plurality of models for each of a plurality of machine learning tasks (e.g., a plurality of models for channel state information prediction, a plurality of models for identifying beamforming parameters, etc.). For a specific machine learning task, different models of the plurality of models may be configured for different data types or quantizations and corresponding levels of computational complexity. For example, a plurality of machine learning models for a specific machine learning task may include low-complexity models, such as models using low-bit-size integers (e.g., 8-bit integers), high-complexity models, such as models using high-bit-size floating point numbers (e.g., 64-bit double precision floating point numbers), and any number of models with complexity between the low complexity models and high-complexity models.

In another example, deploying the generated set of machine learning models may include transmitting, to the UE being configured, parameters associated with each model in the generated set of models. The parameters associated with each model may include information identifying a type of machine learning model (e.g., a convolutional neural network, a recurrent neural network, a recursion-based network, etc.), the data type used by the machine learning model (e.g., single precision floating point, double precision floating point, integer, long integer, etc.), and weights and biases for the model. The UE can use these received parameters to configure the set of machine learning models for subsequent execution and generation of inferences for various purposes in wireless communications (e.g., CSI prediction, precoding matrix prediction, etc.).

In still another example, deploying the generated set of machine learning models may include configuring a processor associated with the UE to perform inferences using models in the generated set of models. The UE may, in this example, configure itself with the one or more machine learning models based on an evaluation of the machine learning models against the compute resource limits established for the UE. The UE may store each model in a global set of models locally and may configure the processor to perform inferences on a subset of models from the global set of models. More specifically, this subset of models, as discussed above, may be a set of models from the global set of models that satisfy the one or more compute resource limits established for the UE. Other models in the global set of models may be designated as unavailable for use until a subsequent time at which a new configuration is identified.

After the generated set of machine learning models is deployed to the UE, the UE can perform inference operations for various purposes in a wireless network using the generated set of machine learning models.

In some aspects, the compute resource limits used to generate a set of machine learning models for the UE may include one or more per-model limits L_{P} that can be used in conjunction with the total limits L_{T} discussed above to determine whether a machine learning model can be included in a set of machine learning models with which the UE can be configured. In one example, a per-model limit may include a peak memory limit, L_{P,P}. The peak memory limit may be defined as the least memory cost for the model. The least memory cost, in some aspects, may be defined as the memory cost associated with a layer in a machine learning model with the largest memory cost.

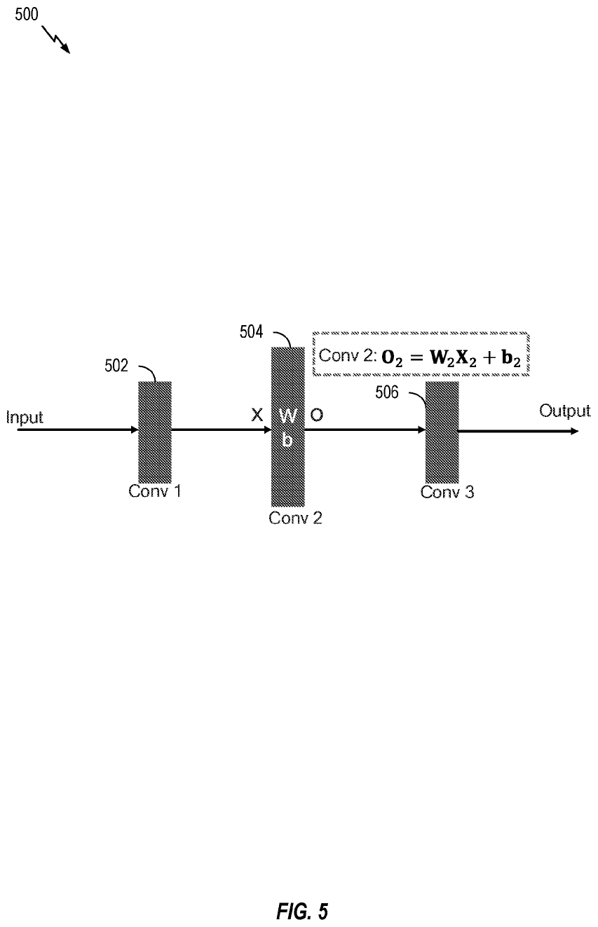

For example, as illustrated in FIG. 5, suppose that a model being examined for inclusion in a set of machine learning models with which a UE may be configured is a convolutional neural network (CNN) 500 with three convolutional layers 502, 504, 506. Each layer may be defined in terms of a parameter memory cost and an activation memory cost, and the second convolutional layer 504 may have the largest parameter memory cost and the largest activation memory cost. Because the second layer 504 in CNN 500 may have the highest memory cost, and because these layers 502, 504, 506 may be executed sequentially (and not in parallel), the memory cost of the second layer 504 may be considered the highest memory cost of the CNN 500. Thus, if the memory cost of the second layer 504 (i.e., the largest layer) is less than L_{P,P}, the CNN 500 may be included in the set of machine learning models with which the UE can be configured. Otherwise, the CNN 500 may be excluded from the set of machine learning models with which the UE can be configured.

The one or more per-model limits L_{P} may also or alternatively include a largest memory cost limit L_{P, L}. This largest memory limit may correspond to the largest memory cost for a model. This largest memory cost for the model may be, for example, the total amount of memory that the machine learning model consumes during operations (e.g., as the sum of memory costs for each layer in a CNN, such as CNN 500). If the total memory cost for a machine learning model exceeds the largest memory cost limit L_{P,L}, the machine learning model may be excluded from the generated set of machine learning models with which the UE may be configured.

In some aspects, the compute resource limits may be defined relative to a reference time duration. The compute resource limits may be valid for a length of time commensurate with the reference time duration from a reference timestamp (e.g., a time at which a configuration message was transmitted, a timestamp included in a configuration message, a time at which the configuration message was received, etc.). After this reference time elapses, a new set of compute resource limits may be used to identify the models with which the UE can be configured. This reference time duration may be defined, for example, based on a duration of a construct in a wireless communication network, such as a duration of a frame, a duration of a subframe, a duration of a slot, or the like.

In some aspects, models may be iteratively added to the generated set of machine learning models with which the UE can be configured until one of the compute resource limits (e.g., one of L_{T}={L_{T, 1}, L_{T, 2}, . . . , L_{T, n}}) is reached. After one of the compute resource limits is reached, the remaining models in a global set of models may be dropped and designated as models which the UE cannot use to perform inferences.

To generate the set of machine learning models with which the UE can be configured, various techniques can be used to identify models to include. In one example, models in the global set of models may each be associated with model priority. The priority level may be based, for example, based on a purpose of the model. In one example, models that facilitate uplink and downlink communications (e.g., CSI prediction models, precoder prediction models, etc.) may be assigned a high priority level, while models for determining UE positioning may be assigned a low priority level. Models in the global set of models may be organized into groups of models, with each group corresponding to one of a plurality of priority levels. Models may thus be selected for inclusion starting with models from the set of machine learning models with the highest priority level and proceeding to models at lower priority levels until one of the compute resource limits is reached. In another example, the group with the highest priority may be examined to determine whether the models in this group satisfy the compute resource limits defined for the UE. If the models in this group satisfy the compute resource limits defined for the UE, the models in this group (and, in some aspects, other models with lower priority levels that can be added without violating the compute resource limits) can be deployed to a UE for use in performing inferences.

In another example, each model in the global set of models may be assigned an index value. Models may be selected based on the indices assigned to each model (e.g., in sequential order from the model with index value 0 or some other value defined as the initial index value). Models may be selected using a random pattern (e.g., based on index values assigned to each model). For example, a random number generator configured to output an index between 0 and n for a global set of n models (or between some starting index i and i+n) can be used to select models at random for evaluation and potential inclusion in the set of models with which the UE can be configured. In another example, a round-robin pattern can be used to determine which models to include in the set of models with which the UE can be configured. This round-robin pattern can be used to select every m^{th} model from the global set of n models, where m<n, until the compute resource limits for the UE are reached.

In some aspects, the compute resource limits may be specified by the UE. The compute resource limits may, for example, be signaled by a UE to a network entity (or other machine learning model manager) and may specify the maximum computational complexity, memory usage, and number of supported models for the set of models with which the UE may be configured. These compute resource limits may be included in UE capability signaling (e.g., exchanged via radio resource control (RRC) signaling, during a random access procedure to connect the UE with the network entity) or in other signaling from the UE to the network entity. In another example, the compute resource limits may be implicitly signaled by the UE reporting a type of the UE to the network entity. The type of the UE may correspond to a defined set of compute resource limits, and the network entity can use the defined set of compute resource limits for the type of the UE to determine which models to include in the set of models with which the UE can be configured.

### Example Wireless Communication Devices

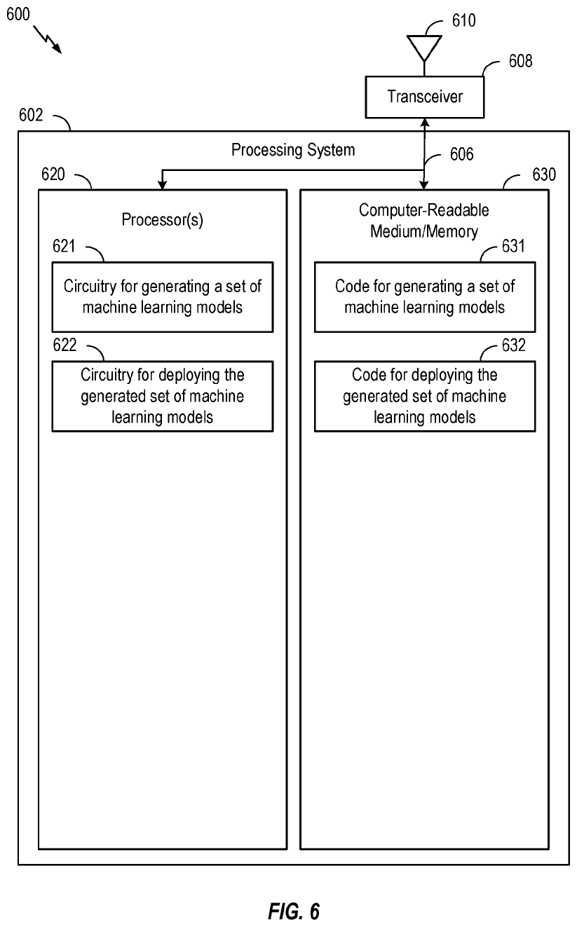

FIG. 6 depicts an example communications device 600 that includes various components operable, configured, or adapted to perform operations for the techniques disclosed herein, such as the operations depicted and described with respect to FIG. 4. In some examples, communication device 600 may be a user equipment 104 as described, for example with respect to FIGS. 1 and 2.

Communications device 600 includes a processing system 602 coupled to a transceiver 608 (e.g., a transmitter and/or a receiver). Transceiver 608 is configured to transmit (or send) and receive signals for the communications device 600 via an antenna 610, such as the various signals as described herein. Processing system 602 may be configured to perform processing functions for communications device 600, including processing signals received and/or to be transmitted by communications device 600.

Processing system 602 includes one or more processors 620 coupled to a computer-readable medium/memory 620 via a bus 606. In certain aspects, computer-readable medium/memory 620 is configured to store instructions (e.g., computer-executable code) that when executed by the one or more processors 620, cause the one or more processors 620 to perform the operations illustrated in FIG. 5, or other operations for performing the various techniques discussed herein to configure a UE with machine learning models to use in performing inferences at the UE.

In the depicted example, computer-readable medium/memory 630 stores code 631 for generating a set of machine learning models and code 632 for deploying the generated set of machine learning models.

In the depicted example, the one or more processors 620 include circuitry configured to implement the code stored in the computer-readable medium/memory 620, including circuitry 621 for generating a set of machine learning models and circuitry 622 for deploying the generated set of machine learning models.

Various components of communications device 600 may provide means for performing the methods described herein, including with respect to FIG. 5.

In some examples, means for transmitting or sending (or means for outputting for transmission) may include the transceivers 254 and/or antenna(s) 252 of the user equipment 104 illustrated in FIG. 2 and/or transceiver 608 and antenna 610 of the communication device 600 in FIG. 6.

In some examples, means for receiving (or means for obtaining) may include the transceivers 254 and/or antenna(s) 252 of the user equipment 104 illustrated in FIG. 2 and/or transceiver 608 and antenna 610 of the communication device 600 in FIG. 6.

In some examples, means for generating a sounding reference signal and means for precoding uplink transmissions may include various processing system components, such as: the one or more processors 620 in FIG. 6, or aspects of the user equipment 104 depicted in FIG. 2, including receive processor 258, transmit processor 264, TX MIMO processor 266, and/or controller/processor 280 (including machine learning model configuration component 281).

Notably, FIG. 6 is just use example, and many other examples and configurations of communication device 600 are possible.

### EXAMPLE CLAUSES

Implementation examples are described in the following numbered clauses:

Clause 1: A method for wireless communications, comprising: generating a set of machine learning models for use in a wireless communications device based on one or more compute resource limits associated with a type of the wireless communications device; and deploying the generated set of machine learning models for use by the wireless communications device in performing one or more inferences with respect to wireless communications based on one or more inputs related to received wireless signals at the wireless communications device.

Clause 2: The method of Clause 1, wherein the one or more compute resource limits comprise one or more total compute resource limits defined for the generated set of machine learning models.

Clause 3: The method of Clause 2, wherein the one or more total compute limits defined for the generated set of machine learning models comprises one or more of a first compute limit associated with total computational complexity, a second compute limit associated with total memory usage, and a third compute limit associated with a total number of machine learning models executed simultaneously.

Clause 4: The method of Clause 3, wherein the first compute limit comprises a maximum number of operations the wireless communications device can process over a time period.

Clause 5: The method of any one of Clauses 2 through 4, wherein generating the set of machine learning models comprises generating a set of machine learning models with properties that satisfy each of the one or more total compute resource limits.

Clause 6: The method of any one of Clauses 1 through 5, wherein the one or more compute resource limits comprise one or more per-model compute resource limits.

Clause 7: The method of Clause 6, wherein the one or more per-model compute resource limits comprises a per-model memory limit against which a maximum memory cost at a layer in a machine learning model is evaluated.

Clause 8: The method of any one of Clauses 6 or 7, wherein the one or more compute resource limits comprises a maximum per-model memory cost.

Clause 9: The method of any one of Clauses 1 through 8, wherein the one or more compute resource limits are associated with a reference time duration.

Clause 10: The method of Clause 9, wherein the reference time duration comprises a duration of a frame in a wireless communication system.

Clause 11: The method of any one of Clauses 9 or 10, wherein the reference time duration comprises a portion of a duration of a frame in a wireless communication system.

Clause 12: The method of any one of Clauses 1 through 11, wherein generating the set of machine learning models comprises: until at least one of the one or more compute resource limits is reached: selecting a model from a global set of models, accumulating compute limit statistics for the selected model and models included in the generated set of models, and upon determining that the accumulated compute limit statistics are below the one or more compute resource limits, adding the selected model to the generated set of models; and after at least one of the one or more compute resource limits is reached, discarding remaining models from the global set of models.

Clause 13: The method of Clause 12, wherein selecting the model from the global set of models comprises selecting the model based on a prioritization associated with the selected model.

Clause 14: The method of Clause 13, wherein the global set of models comprises a plurality of models grouped into a plurality of groups, each group of the plurality of groups being associated with one of a plurality of prioritization levels.

Clause 15: The method of any one of Clauses 13 or 14, wherein selecting the model from the global set of models comprises selecting models in descending order based on prioritization associated with each model in the global set of models.

Clause 16: The method of any one of Clauses 12 through 15, wherein selecting the model from the global set of models is based on an index associated with a scheduling time for performing one or more operations using the generated set of machine learning models.

Clause 17: The method of any one of Clauses 12 through 16, wherein selecting the model from the global set of models comprises randomly selecting the model from the global set of models.

Clause 18: The method of any one of Clauses 1 through 17, further comprising: receiving, from the wireless communications device, information identifying the one or more compute resource limits.

Clause 19: The method of Clause 18, wherein the information identifying the one or more compute resource limits comprises an indication of a type of the wireless communications device, wherein the indicate type of the wireless communications device is associated with a set of compute resource limits.

Clause 20: The method of any one of Clauses 1 through 19, wherein deploying the generated set of machine learning models comprises transmitting, to the wireless communications device, identifiers associated with models in the generated set of models.

Clause 21: The method of any one of Clauses 1 through 20, wherein deploying the generated set of machine learning models comprises transmitting, to the wireless communications device, parameters associated with each model in the generated set of models.

Clause 22: The method of any one of Clauses 1 through 21, wherein deploying the generated set of machine learning models comprises configuring a processor associated with the wireless communications device to perform inferences using models in the generated set of models.

Clause 23: A processing system, comprising: a memory comprising computer-executable instructions; and one or more processors configured to execute the computer-executable instructions and cause the processing system to perform a method in accordance with any one of Clauses 1-22.

Clause 24: A processing system, comprising: means for performing a method in accordance with any one of Clauses 1-22.

Clause 25: A non-transitory computer-readable medium comprising computer-executable instructions that, when executed by one or more processors of a processing system, cause the processing system to perform a method in accordance with any one of Clauses 1-22.

Clause 26: A computer program product embodied on a computer-readable storage medium comprising code for performing a method in accordance with any one of Clauses 1-22.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 us.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of sounding and transmission precoding matrix indication determination for uplink transmissions using machine learning models in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications, comprising:
generating a set of machine learning models for use in a wireless communications device based on one or more compute resource limits associated with a type of the wireless communications device; and
deploying the generated set of machine learning models for use by the wireless communications device in performing one or more inferences with respect to wireless communications based on one or more inputs related to received wireless signals at the wireless communications device.

2. The method of claim 1, wherein the one or more compute resource limits comprise one or more total compute resource limits defined for the generated set of machine learning models.

3. The method of claim 2, wherein the total one or more compute limits defined for the generated set of machine learning models comprises one or more of a first compute limit associated with total computational complexity, a second compute limit associated with total memory usage, and a third compute limit associated with a total number of machine learning models executed simultaneously.

4. The method of claim 3, wherein the first compute limit comprises a maximum number of operations the wireless communications device can process over a time period.

5. The method of claim 2, wherein generating the set of machine learning models comprises generating a set of machine learning models with properties that satisfy each of the one or more total compute resource limits.

6. The method of claim 1, wherein the one or more compute resource limits comprise one or more per-model compute resource limits.

7. The method of claim 6, wherein the one or more per-model compute resource limits comprises a per-model memory limit against which a maximum memory cost at a layer in a machine learning model is evaluated.

8. The method of claim 6, wherein the one or more compute resource limits comprises a maximum per-model memory cost.

9. The method of claim 1, wherein the one or more compute resource limits are associated with a reference time duration.

10. The method of claim 9, wherein the reference time duration comprises a duration of a frame in a wireless communication system.

11. The method of claim 9, wherein the reference time duration comprises a portion of a duration of a frame in a wireless communication system.

12. The method of claim 1, wherein generating the set of machine learning models comprises:
until at least one of the one or more compute resource limits is reached:
selecting a model from a global set of models,
accumulating compute limit statistics for the selected model and models included in the generated set of models, and
upon determining that the accumulated compute limit statistics are below the one or more compute resource limits, adding the selected model to the generated set of models; and
after at least one of the one or more compute resource limits is reached, discarding remaining models from the global set of models.

13. The method of claim 12, wherein selecting the model from the global set of models comprises selecting the model based on a prioritization associated with the selected model.

14. The method of claim 13, wherein the global set of models comprises a plurality of models grouped into a plurality of groups, each group of the plurality of groups being associated with one of a plurality of prioritization levels.

15. The method of claim 13, wherein selecting the model from the global set of models comprises selecting models in descending order based on prioritization associated with each model in the global set of models.

16. The method of claim 12, wherein selecting the model from the global set of models is based on an index associated with a scheduling time for performing one or more operations using the generated set of machine learning models.

17. The method of claim 12, wherein selecting the model from the global set of models comprises randomly selecting the model from the global set of models.

18. The method of claim 1, further comprising:
receiving, from the wireless communications device, information identifying the one or more compute resource limits.

19. The method of claim 18, wherein the information identifying the one or more compute resource limits comprises an indication of a type of the wireless communications device, wherein the indicate type of the wireless communications device is associated with a set of compute resource limits.

20. The method of claim 1, wherein deploying the generated set of machine learning models comprises transmitting, to the wireless communications device, identifiers associated with models in the generated set of models.

21. The method of claim 1, wherein deploying the generated set of machine learning models comprises transmitting, to the wireless communications device, parameters associated with each model in the generated set of models.

22. The method of claim 1, wherein deploying the generated set of machine learning models comprises configuring a processor associated with the wireless communications device to perform inferences using models in the generated set of models.

23-26. (canceled)

27. An apparatus for wireless communication, comprising:
at least one memory comprising computer-executable instructions; and
one or more processors configured to execute the computer-executable instructions and cause the apparatus to:
generate a set of machine learning models for use in a wireless communications device based on one or more compute resource limits associated with a type of the wireless communications device; and
deploy the generated set of machine learning models for use by the wireless communications device in performing one or more inferences with respect to wireless communications based on one or more inputs related to received wireless signals at the wireless communications device.

28. A computer readable medium having instructions stored thereon for:
generating a set of machine learning models for use in a wireless communications device based on one or more compute resource limits associated with a type of the wireless communications device; and
deploying the generated set of machine learning models for use by the wireless communications device in performing one or more inferences with respect to wireless communications based on one or more inputs related to received wireless signals at the wireless communications device.
